(19) United States
(12) Patent Application Publication
(10) Pub. No.: US 2013/0255981 A1
(43) Pub. Date: Oct. 3, 2013

(54) POWER TOOL

(71) Applicant: HITACHI KOKI CO., LTD., Tokyo (JP)

(72) Inventors: Keiko Noto, Ibaraki (JP); Katsuhiro Oomori, Ibaraki (JP)

(73) Assignee: HITACHI KOKI CO., LTD., Tokyo (JP)

(21) Appl. No.: 13/769,178

(22) Filed: Feb. 15, 2013

(30) Foreign Application Priority Data
Mar. 27, 2012 (JP) 2012-071292

(51) Int. Cl. B25F 5/00

(52) U.S. Cl. CPC B25F 5/001
USPC 173/20; 173/217

(57) ABSTRACT

In addition to improvement of operability, a small size with a light weight and a long life are achieved. A switch housing unit and a control-part housing unit are provided in a housing, a switch unit provided with a pressure switch which generates an electric signal by performing a pressing operation by a worker is housed in the switch housing unit, a switch cover which covers the pressure switch and which is elastically deformed by the pressing operation by the worker is provided, and the control-part houses a control circuit board which controls a rotation state of a motor in accordance with a magnitude of the electric signal outputted from the pressure switch.

### CROSS-REFERENCE TO RELATED APPLICATION

The present application claims priority from Japanese Patent Application No. 2012-071292 filed on Mar. 27, 2012, the content of which is hereby incorporated by reference into this application.

### TECHNICAL FIELD OF THE INVENTION

The present invention relates to a power tool provided with an electric motor having a rotary shaft and a housing which houses the electric motor.

### BACKGROUND OF THE INVENTION

Conventionally, such power tools as an impact driver, a driver drill, and a disc grinder have been known as a portable power tool, and any one of these is provided with an electric motor having a rotary shaft, a housing main body which houses the electric motor, and a grip which is integrally formed with the housing main body and is held by a worker. As the electric motor, a brushless DC motor having no brush which is a consumable supply is adopted inmost cases, so that a power tool is achieved with improving maintainability as achieving downsizing and light weight, and besides, with superior torque characteristics (controllability). That is, by adopting the brushless DC motor and sequentially carrying a large driving current to a plurality of coils (U phase, V phase, and W phase) in an inverter circuit provided with a plurality of FETs (field effect transistors) and others, a power tool which can tighten a screw, a bolt, or others against a workpiece such as wood with a stronger force but a small size can be achieved.

As such a power tool, for example, a power tool described in Japanese Patent Application Laid-Open Publication No. 2011-148065 (Patent Document 1) (FIG. 1) has been known. The power tool described in the Patent Document 1 is an impact tool provided with a hammer and an anvil, and the impact tool is provided with a housing formed of a body unit (housing main body), a grip unit (grip) and a battery holding unit. In the body unit, a brushless DC motor (electric motor) having a rotary shaft is housed. In the grip unit, a trigger switch having a trigger operation unit is housed. In the grip unit on the battery holding unit side, a control circuit board (control part) used for controlling speed of the brushless DC motor by an operation in the trigger operation unit is provided. This control circuit board is arranged adjacent to a battery pack so as to lie substantially immediately above the battery pack (secondary battery).

### SUMMARY OF THE INVENTION

Incidentally, in the portable power tool, it is desired to improve the operability, and besides, to achieve a smaller size with lighter weight and a longer life. However, according to the power tool described in the above-described Patent Document 1, the trigger switch having the trigger operation unit is adopted as a switch to be operated by the worker for driving to rotate the electric motor. This trigger switch is provided with a slide-type contact (slide switch) having a relatively long stroke, which is located on a rear side of the trigger operation unit, and besides, with a spring member (return spring) used for returning the trigger operation unit that has been pulled in operation to an original position. Therefore, in a case that a lot of screws are tightened or other case, the worker needs to pull the trigger operation unit having the long stroke in operation against a reaction force of the spring member many times, and therefore, it cannot be always said that the operability is sufficient. Moreover, since the trigger switch has a large size because of the slide-type contact and the spring member, a volume inside the grip which is occupied by the trigger switch, that is, a housing space for the trigger switch becomes is increased, and this increase is a disadvantage in achieving the power tool having the smaller size with the lighter weight. Further, since the control part is arranged adjacent to the secondary battery, heat radiating characteristics of the control part and the secondary battery are lowered, and, as a result, a problem of a short life of the power tool is caused.

A preferred aim of the present invention is to provide a power tool capable of improving operability, and besides, achieving a small size with a light weight and a long life.

A power tool according to an embodiment includes: an electric motor having a rotary shaft; a housing which houses the electric motor; a switch housing unit and a control-part housing unit which are provided in the housing; a pressure switch which is housed in the switch housing unit and which generates an electric signal by a pressing operation by a worker; an operation cover which is provided in the housing and which is elastically deformed by the pressing operation by the worker; and a control part which is housed in the control-part housing unit and which controls a rotation state of the electric motor in accordance with a magnitude of the electric signal outputted from the pressure switch.

According to the present invention, by using the pressure switch, a dimension in thickness thereof along an operation direction can be smaller than a dimension in thickness along an operation direction of a conventional trigger switch, and, as a result, a smaller size with a lighter weight of the power tool can be achieved. Moreover, for example, the pressure switch and the control part can be arranged adjacent to each other inside the housing, and therefore, the control part can be distant away from a heat generating member such as the secondary battery, and, as a result, the long life of the power tool can be achieved. Further, an operation amount (pressing amount) of the pressure switch can be smaller than an operation amount (sliding amount) of the conventional trigger switch, and therefore, the operability of the power tool can be improved. Still further, since the operation cover is provided, touch in the operation of the pressure switch can be softer so as to further improve the operability as the pressure switch is protected from an impact or others, and therefore, the long life of the power tool can be achieved.

### BRIEF DESCRIPTIONS OF THE DRAWINGS

FIG. 1 is a perspective view illustrating an impact driver according to the present invention;

FIG. 2 is a partial cross-sectional view of the impact driver viewed in an arrow “A” direction of FIG. 1;

FIG. 3 is a view on an arrow “B” of FIG. 1;

FIG. 4 is a perspective view illustrating a switch cover which covers a switch unit;

FIG. 5 is a block diagram illustrating an electric system of the impact driver;

FIG. 6 is a characteristic diagram illustrating a relation between a pulling load of a pressure switch and the number of revolutions of a motor; and

FIG. 7 is an explanatory view for explaining a passage of air flowing inside a housing.

### DESCRIPTIONS OF THE PREFERRED EMBODIMENTS

Hereinafter, an embodiment of the present invention will be explained in detail with reference to drawings.

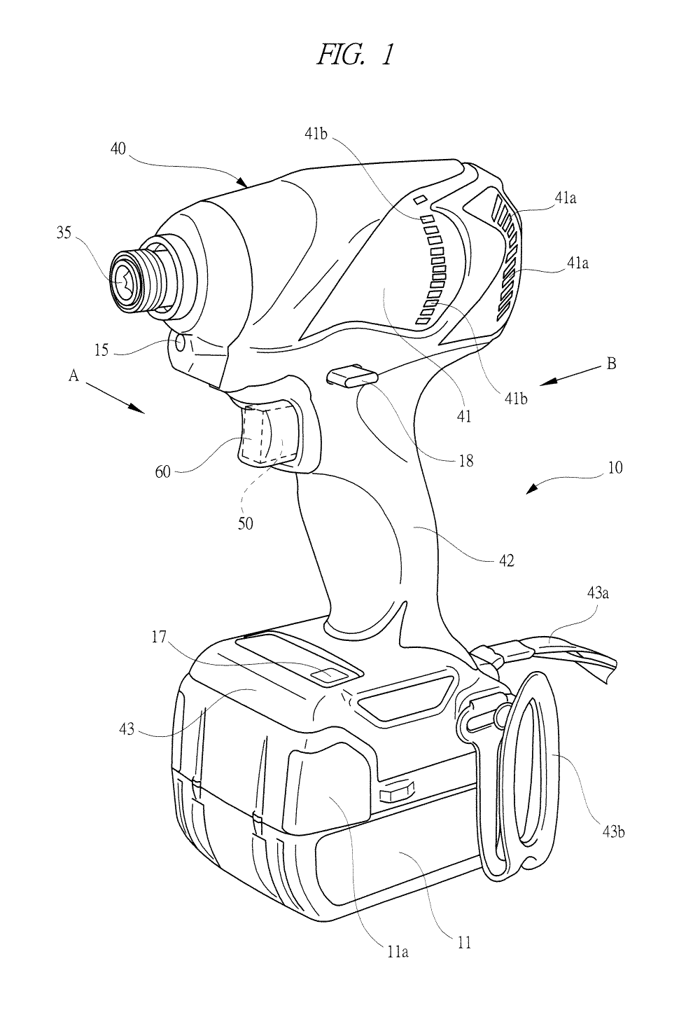

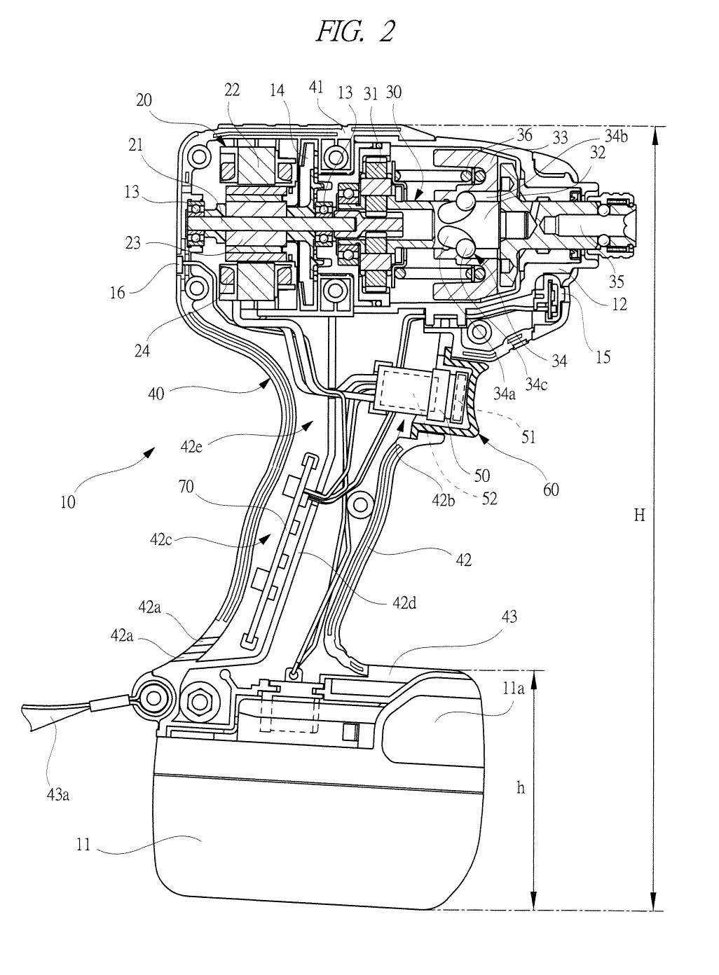

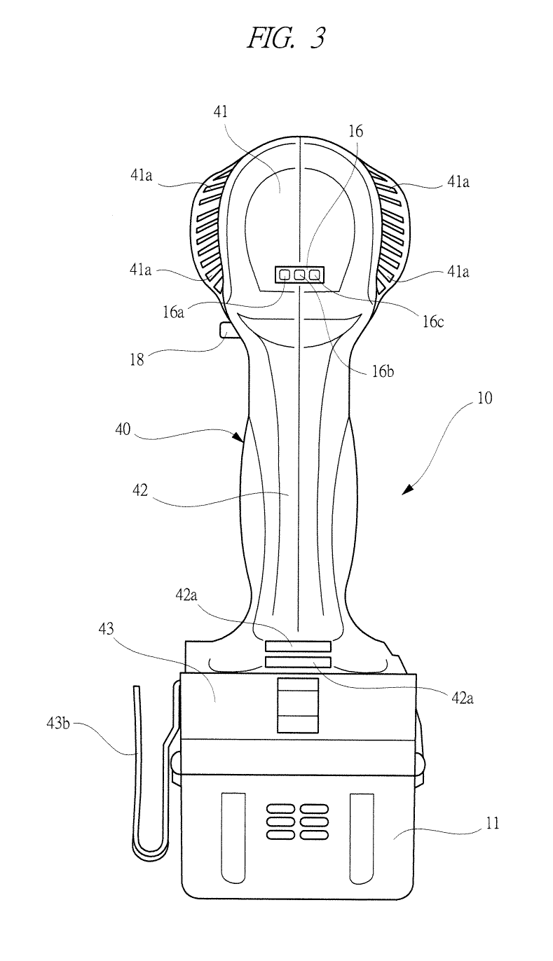

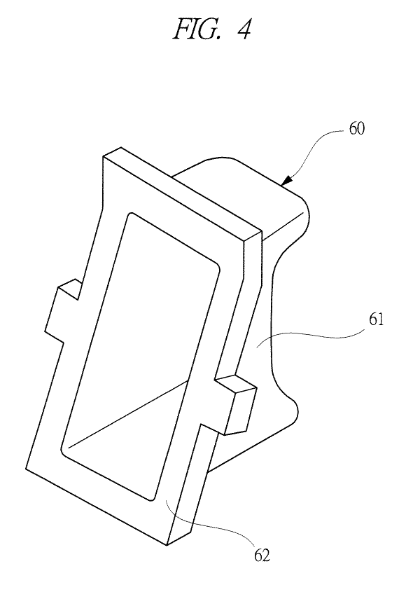

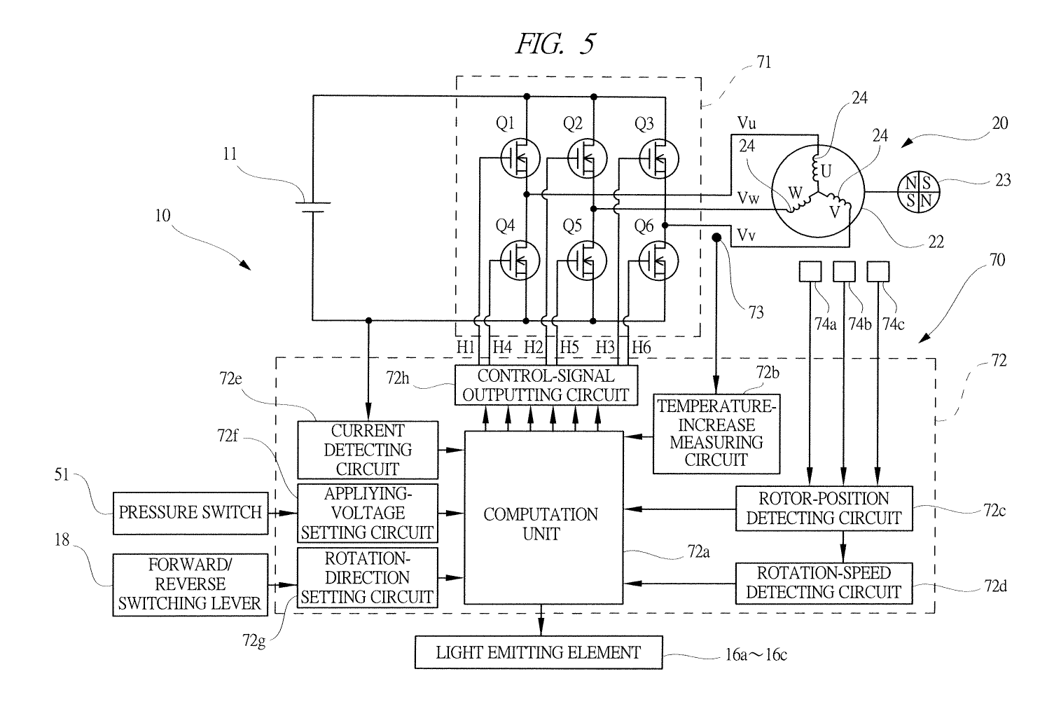

FIG. 1 is a perspective view illustrating an impact driver according to the present invention, FIG. 2 is a partial cross-sectional view of the impact driver viewed in an arrow A direction of FIG. 1, FIG. 3 is a view on an arrow B of FIG. 1, FIG. 4 is a perspective view illustrating a switch cover which covers a switch unit, and FIG. 5 is a block diagram illustrating an electric system of the impact driver.

As illustrated in FIGS. 1 and 2, an impact driver 10 serving as a power tool is provided with a chargeable battery (secondary battery) 11, and a motor (electric motor) 20 is driven by the battery 11 serving as a power supply. The motor 20 drives a rotary impacting mechanism 30, and the rotary impacting mechanism 30 applies rotation and impact to an anvil 35 serving as an output shaft, so that a continuous rotary force and an intermittent impact force are transferred to a tip tool (not illustrated) such as a driver bit. In this manner, the impact driver 10 can perform such an operation as fastening a screw, a bolt, and others with a strong force.

The impact driver 10 is provided with a housing 40 which forms an outline thereof. The housing 40 is formed so as to have a substantially T shape viewed from a side thereof by mold injection of a resin material such as plastic. The housing 40 is divided into left- and right-side portions (front- and rear-side portions in FIG. 2) so as to sandwich a rotary shaft 21 of the motor 20, and the housing 40 is hollow inside under a state that these portions are combined with each other. The housing 40 is provided with a housing main body 41 which extends in an axis direction of the rotary shaft 21, a grip 42 which extends in a direction substantially orthogonal to the axial direction of the rotary shaft 21, and a battery holding unit 43 provided opposite to the housing main body 41 so as to interpose the grip 42, and they are integrally provided.

As illustrated in FIG. 2, inside the housing main body 41, the motor 20 including a brushless DC motor and a hammer case 12 for housing the rotary impacting mechanism 30 are housed. The hammer case 12 is arranged on one side (front which is a right side in the drawing) along the axial direction of the rotary shaft 21, and the motor 20 is arranged on the other side (rear which is a left side in the drawing) along the axial direction of the rotary shaft 21. That is, the motor 20 and the hammer case 12 are coaxially arranged so as to be centered on the rotary shaft 21.

The motor 20 is provided with a stator 22 formed in a ring shape and a rotor 23 formed in a cylindrical shape. A plurality of coils 24 are wound around the stator 22 in a predetermined winding form, and the stator 22 is fixed at the housing main body 41. Meanwhile, the rotor 23 is formed of a plurality of magnetized permanent magnets along a circumferential direction, and the rotor 23 is provided so as to be rotatable with a fine gap (air gap) inside the stator 22 in a radial direction. In this manner, by sequentially supplying a driving current to each of the coils 24, the rotor 23 is rotated at a predetermined rotation speed.

The rotary shaft 21 is fixed at a rotation center of the rotor 23 so as to penetrate therethrough, and the rotary shaft 21 is supported on one side thereof and the other side thereof in the axis direction so as to be rotatable by a pair of bearings 13 each fixed at the housing main body 41. In this manner, the rotor 23 is smoothly rotated without being in contact with the stator 22.

A cooling fan 14 is fixed between the rotor 23 and the bearing 13 on one side of the rotary shaft 21 in the axial direction. The cooling fan 14 is made of a resin material such as plastic, and rotates in accordance with the rotation of the rotary shaft 21. In this manner, outside air (air) is introduced into the housing 40, so that heat generating parts such as the motor 20 and a control circuit board 70 are cooled.

As illustrated in FIGS. 1 and 3, on the rear side of the housing main body 41, a plurality of first outside-air introducing holes 41a used for introducing the outside air into the housing main body 41 are provided. Moreover, as illustrated in FIGS. 2 and 3, on the rear side of the grip 42, a plurality of second outside-air introducing holes 42a used for introducing the outside air into the grip 42 are provided. Further, as illustrated in FIG. 1, on a substantially center portion of the housing main body 41 in a longitudinal direction, a plurality of outside-air exhausting holes 41b used for exhausting the outside air, which has been introduced into the housing 40, that is, into the housing main body 41 and the grip 42, to an outside of the housing 40 are provided.

As illustrated in FIG. 2, the rotary impacting mechanism 30 housed in the hammer case 12 is provided with a planetary gear mechanism 31, a spindle 32, and a hammer 33. The planetary gear mechanism 31 is provided between the rotary shaft 21 and the spindle 32, reduces the rotation of the rotary shaft 21 to generate a high torque, and transfers a rotary force with the high torque to the spindle 32. Moreover, a cam mechanism 34 is provided between the spindle 32 and the hammer 33, and the cam mechanism 34 is formed of a substantially V-shaped spindle cam trench 34a which is formed on an outer circumferential surface of the spindle 32, a hammer cam trench 34b which is formed on an inner circumferential surface of the hammer 33, and steel balls 34c each of which is engaged with the cam trenches 34a and 34b.

An anvil 35 to which a tip tool is attached is provided on a front side of the hammer 33, and convex portions (not illustrated) which can be engaged with each other and engagement-releasable from each other are formed on the hammer 33 side (rear side) of the anvil 35 and on the anvil 35 side (front side) of the hammer 33 so as to be opposite to each other. Moreover, a coil spring 36 is provided between the planetary gear mechanism 31 and the hammer 33 so that the hammer 33 is always biased by the coil spring 36 toward the front side, that is, the anvil 35 side.

When an operation of the rotary impacting mechanism 30 is explained here, the convex portions in the anvil 35 and the hammer 33 are in the engaging-enable state with each other by the engagement of the steel ball 34c with each of the cam trenches 34a and 34b in no rotation of the rotary shaft 21, that is, in stop of the impact driver 10. And, when the rotary shaft 21 is rotated in this state, the spindle 32 is accordingly rotated through the planetary gear mechanism 31, and the rotary force of the spindle 32 is transferred to the hammer 33 through the cam mechanism 34. In this manner, the convex portions in the hammer 33 and anvil 35 are engaged with each other so that the anvil 35 is rotated.

Then, when the anvil 35 is difficult to rotate due to, for example, increase in the rotary torque of the tip tool, an engagement reaction force between the respective convex portions is large at this time, and relative rotation occurs between the spindle 32 and the hammer 33, and, as a result, the engagement of the steel ball 34c with each of the cam trenches 34a and 34b is released so that the hammer 33 recedes toward the motor 20 side as pressing the coil spring 36. And, by the receding of the hammer 33, the respective convex portions in the hammer 33 and the anvil 35 are crossed over each other so that the engagement is released.

At this time, the rotary force of the spindle 32 and the elastic force of the coil spring 36 are applied to the hammer 33, so that the hammer 33 is rapidly accelerated toward the anvil 35 as being rotated. Then, the convex portion of the hammer 33 and the convex portion of the anvil 35 are vigorously engaged with each other again, a strong rotary impacting force generated at this time is transferred to the anvil 35, that is, the tip tool. Then, the engagement release between the respective convex portions in the hammer 33 and the anvil 35 and the impactful engagement therebetween are repeated, so that the rotary impacting force can be intermittently transferred to a screw or others through the tip tool, and, as a result, the screw or others can be exactly screwed into a member to be fastened (worked), such as wood.

Inside the housing main body 41, an LED light 15 and a display panel (display unit) 16 are provided in the motor 20 and the hammer case 12 on the grip 42 side. The LED light 15 is arranged on the hammer case 12 side of the housing main body 41, that is, the front side thereof to which the tip tool is attached so that a periphery (periphery of a working area) of the tip tool can be illuminated by turning on a light switch 17 (see FIG. 1) provided in the battery holding unit 43, the LED light 15 is allowed to illuminate. In this manner, the workability for the screw fastening operation or others in dark environment can be improved.

On the other hand, the display panel 16 is arranged on the motor 20 side of the housing main body 41, that is, on the rear side thereof opposite to the front side to which the tip tool is attached so as to be easily viewed by the worker. The display panel 16 is provided with three light emitting elements (LEDs) 16a, 16b, and 16c as illustrated in FIG. 3, and the number of lighted elements of these light emitting elements 16a to 16c is gradually increased as increase in the rotary speed of the rotary shaft 21. That is, the display panel 16 is used for displaying a rotation state of the motor 20, and a specific displaying operation thereof will be explained later. Note that the provision of the display panel 16 is not limited on the rear side of the housing main body 41, and may be provided on an upper side or a lower side of the grip 42 in the longitudinal direction which is also on the rear side of the rotary shaft 21 in the axial direction.

The grip 42 is integrally provided with the housing main body 41, and is held by the worker. As illustrated in FIG. 2, inside the grip 42, a switch housing unit 42b and a control-part housing unit 42c are provided adjacent to each other. The switch housing unit 42b is provided on one side (front side) of the rotary shaft 21 of the grip 42 in the axial direction which is also on the housing main body 41 side, and the control-part housing unit 42c is provided on the other side (rear side) of the rotary shaft 21 of the grip 42 in the axial direction.

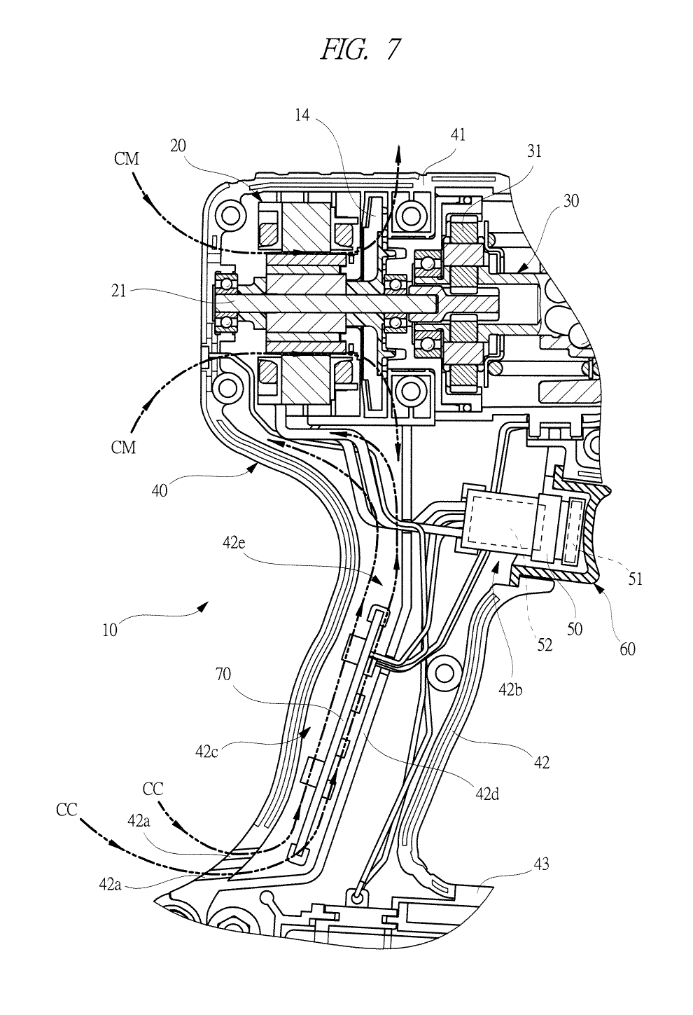

A partition wall 42d is provided between the switch housing unit 42b and the control-part housing unit 42c so as to extend in the longitudinal direction (vertical direction in the drawing) of the grip 42, and the partition wall 42d divides the inside of the grip 42 into the switch housing unit 42b side and the control-part housing unit 42c side. In this manner, the outside air which has been introduced from the second outside-air introducing holes 42a into the control-part housing unit 42c by the rotation of the cooling fan 14 is flown from the battery holding unit 43 side to the housing main body 41 side in the longitudinal direction of the grip 42 (see FIG. 7). That is, on the control-part housing unit 42c side of the partition wall 42d, an air passage 42e is provided, the air passage extending from one side (lower side) in the longitudinal direction of the grip 42 toward the other side (upper side) therein and crossing the control-part housing unit 42c.

A switch unit 50 is housed in the switch housing unit 42b. The switch unit 50 is provided with a pressure switch 51 formed of a plate-shaped piezoelectric element (piezo element) and an amplifier member (amplifier circuit) 52 which amplifies a voltage signal (electric signal) outputted from the pressure switch 51. A front side of the pressure switch 51 is protruded from the grip 42 to the front side of the grip 42 in order to improve the operability, so that the worker can easily perform the pressing operation of the pressure switch 51 with his/her forefinger or others by holding the grip 42.

Here, the pressure switch 51 generates a voltage signal having a magnitude in proportion to a magnitude of the pressing force in accordance with the pressing force applied in its thickness direction from the worker. Moreover, by releasing the pressing force applied for the pressure switch 51, that is, by performing the releasing operation with separating the forefinger or others from the pressure switch 51, the generation of the voltage signal is stopped. Note that a plate-shaped strain gauge can be used instead of the plate-shaped piezoelectric element. In this case, change in a resistance value of the strain gauge is handled as the electric signal.

In this manner, by using the plate-shaped pressure switch 51, a degree of the protrusion of the switch unit 50 into the grip 42 is reduced, and, as a result, a size of the switch housing unit 42b can be smaller than that of a conventional trigger switch. In this manner, a relatively large space is ensured on the rear side of the switch unit 50 so that the partition wall 42d, the control-part housing unit 42c, and the air passage 42e can be formed in the space.

Here, as illustrated in FIG. 1, a forward/reverse switching lever 18 is provided in vicinity of the switch unit 50 on the housing main body 41 side in the longitudinal direction of the grip 42. The forward/reverse switching lever 18 is turned on/off by the worker with his/her thumb or others. By performing the on-operation or off-operation of the forward/reverse switching lever 18, a rotation direction of the rotary shaft 21 is switched to forward rotation or reverse rotation.

The protruding portion of the switch unit 50 from the grip 42, that is, the front side of the pressure switch 51, is covered with a switch cover 60 serving as an operation cover. As illustrated in FIG. 4, the switch cover 60 is made of an elastic material having superior flexibility, such as ethylene propylene rubber (EPDM), so that the switch cover 60 is elastically deformed by the pressing operation performed by the worker. The switch cover 60 is formed in a substantially box shape, and is provided with a bottomed main body unit 61 which covers the switch unit 50 on the pressure switch 51 side, and a flange unit 62 which is integrally provided on the entire circumference of the main body unit 61 on an opening side and which is sandwiched by the dividable housing 40.

And, the flange unit 62 is sandwiched by the housing 40 so as to be inserted into an attaching concave portion (not illustrated) provided in the housing 40, so that the switch housing unit 42b of the grip 42 is sealed. A contact portion between the switch cover 60 and the housing 40 has a labyrinth structure (not illustrated in detail). By this labyrinth structure, entering of rain water, dust, and others into the housing 40 is exactly prevented, and therefore, long lives of components provided inside the housing 40 such as the switch unit 50 are achieved. Moreover, by provided the switch cover 60, the pressure switch 51 can be protected, and the operational touch of the pressure switch 51 is made softer, which results in operation with the soft touch, and besides, slipping in the pressing operation can be prevented, and, as a result, the operability of the pressure switch 51 can be further improved.

As illustrated in FIG. 2, a control circuit board 70 is housed as the control part in the control-part housing unit 42c, and the control circuit board 70 controls the rotation state of the motor 20 in accordance with the magnitude of the voltage signal outputted from the pressure switch 51. The control circuit board 70 is provided lengthwise in the longitudinal direction of the grip 42, so that the air passage 42e is not closed in order not to prevent the flow of the outside air. In this manner, since the control circuit board 70 is arranged in the grip 42 on the rear side of the switch unit 50 so as to be distant away from the battery 11, heat generated from the battery 11 is hardly transmitted to the control circuit board 70, and heat generated from the control circuit board 70 is hardly transmitted to the battery 11. In this manner, the long life of the impact driver 10 can be achieved.

Moreover, it is not required that the control circuit board 70 is conventionally arranged so as to lie substantially above the battery 11, and therefore, a height dimension “h” including the battery holding unit 43 and the battery 11 can be smaller than a conventional one. Therefore, an entire height dimension “H” of the impact driver 10 can be shortened by a shortened amount of the height dimension h including the battery holding unit 43 and the battery 11, and, as a result, the impact driver 10 can be downsized.

The battery holding unit 43 holds the battery 11. As illustrated in FIGS. 1 and 2, a release button 11a is provided in the battery 11. By sliding the battery 11 forward with respect to the battery holding unit 43 as holding the release button 11a, the battery 11 can be detached from the battery holding unit 43. Moreover, a hand strap 43a is attached onto the rear side of the battery holding unit 43, and a metallic belt hanger 43b is attached onto the left side (front side in FIG. 1) of the battery holding unit 43. Note that the belt hanger 43b is attachable/detachable to the battery holding unit 43, and can be also attached onto the right side (rear side in FIG. 1) of the battery holding unit 43.

As illustrated in FIG. 5, the control circuit board 70 is provided with an inverter unit 71 including a plurality of switching elements (FETs) Q1 to Q6 and a control unit 72 including a computation unit 72a and a plurality of other electric circuits. And, the respective coils 24 (U phase, V phase, and W phase) of the motor 20, the pressure switch 51 (amplifier member 52), the forward/reverse switching lever 18, the respective light emitting elements 16a to 16c, the battery 11, a temperature sensor 73, and three rotor-position detection elements (Hall elements) 74a to 74c are electrically connected to the control circuit board 70.

The motor 20 is a brushless DC motor of an inner rotor type, and is provided with: a rotor 23 including a plurality of pairs of N poles and S poles; a stator 22 around which a coil 24 is wound, the coil being formed of U phase, V phase, and W phase (three phases) which are star-connected; the three rotor-position detection elements 74a to 74c arranged in the circumferential direction of the stator 22 at a predetermined interval (for example, interval of 60°) in order to detect a rotation position of the rotor 23; and the temperature sensor 73 which is provided in vicinity of the each coil 24 and which detects a temperature of the motor 20.

A detection signal outputted from the temperature sensor 73 is inputted to a temperature-increase measuring circuit 72b of the control unit 72, and is outputted as a temperature data of the motor 20 (respective coils 24) from the temperature-increase measuring circuit 72b to the computation unit 72a. In this manner, when the motor 20 has an abnormally high temperature, that is, when burning of the motor occurs, the computation unit 72a leads the motor 20 to emergency stop (performs fail safe operation).

A detection signal outputted from each of the rotor-position detection elements 74a to 74c is inputted to a rotor-position detecting circuit 72c of the control unit 72, and is outputted as a rotation-position data of the rotor 23 from the stator-position detecting circuit 72c to the computation unit 72a. Moreover, the detection signal outputted from each of the rotor-position detection elements 74a to 74c is inputted to a number-of-revolution detecting circuit 72d through the rotor-position detecting circuit 72c, and is outputted as a data of the number of revolutions of the rotor 23 from the number-of-revolution detecting circuit 72d to the computation unit 72a. In this manner, the computation unit 72a recognizes a present rotation state (the rotation position or the number of revolutions) of the motor 20, and then, controls the rotation state of the motor 20 based on the recognition.

In the control unit 72, a current detecting circuit 72e for detecting a value of a current flowing through the inverter unit 71 is provided, so that a present value of the current being supplied to the motor 20 is fed back to the computation unit 72a. And, when the computation unit 72a detects a fact that the overcurrent is flowing through the motor 20 due to, for example, the increase in the load for the motor 20, the computation unit 72a controls a control-signal output circuit 72h so as to lead the motor 20 to the emergency stop (perform the fail safe operation).

A voltage signal outputted from the pressure switch 51 (amplifier member 52) is inputted to an applying-voltage setting circuit 72f of the control unit 72, and the applying-voltage setting circuit 72f adjusts the voltage signal outputted from the pressure switch 51 to generate an operation-amount data, and outputs this operation-amount data to the computation unit 72a. That is, when the pressure switch 51 is pressed in the operation with a weak force by the worker, the operation-amount data to be outputted to the computation unit 72a is small. When the pressure switch 51 is pressed in the operation with a strong force by the worker, the operation-amount data to be outputted to the computation unit 72a is large.

A switching signal outputted from the forward/reverse switching lever 18 is inputted to a rotation-direction setting circuit 72g of the control unit 72, and is outputted as the forward rotation data or the reverse rotation data from the rotation-direction setting circuit 72g to the computation unit 72a. Based on the forward rotation data or the reverse rotation data, the computation unit 72a drives the rotor 23 to rotate in the forward direction or the reverse direction.

The inverter unit 71 is provided with six switching elements Q1 to Q6 which are electrically connected in a three-phase bridge form, and each gate of the switching elements Q1 to Q6 is electrically connected to the control-signal output circuit 72h of the control unit 72. Moreover, each drain or each source of the switching elements Q1 to Q6 is electrically connected to each coil 24 of the U phase, V phase, and W phase. In this manner, the respective switching elements Q1 to Q6 perform switching operations with using respective switching-element driving signals H1 to H6 outputted from the control-signal output circuit 72h so that power is supplied to each coil 24 with taking direct-current voltages of the battery 11 to be applied to the inverter unit 71 as three-phase voltages Vu, Vv, and Vw.

Among the respective switching-element driving signals H1 to H6 used for driving the respective gates of the respective switching elements Q1 to Q6, the respective pulse-width modulation signals (PWM signals) H4 to H6 are supplied to the three switching elements Q4 to Q6 on a negative power-supply side. In this manner, by the computation unit 72a of the control unit 72, a pulse width (duty ratio) of the PWM signal is changed based on the operation-amount data in accordance with the operation amount (pressing amount) of the pressure switch 51, and a power-supply amount to the motor 20 is adjusted, so that the driving, the stopping, and the rotation speed of the motor 20 are controlled.

Here, the PWM signal is supplied to either one of a group of the switching elements Q1 to Q3 on a positive power-supply side of the inverter unit 71 or the other group of the switching elements Q4 to Q6 on the negative power-supply side thereof to switch the switching elements Q1 to Q3 or Q4 to Q6 at a high speed, so that the respective voltages Vu, Vv, and Vw are controlled with using the direct-current voltage of the battery 11. Note that the PWM signal is supplied to the switching elements Q4 to Q6 on the negative power-supply side in the present embodiment, and therefore, the power to be supplied to each coil 24 can be adjusted so as to control the rotation speed of the motor 20 by controlling the pulse width of the PWM signal.

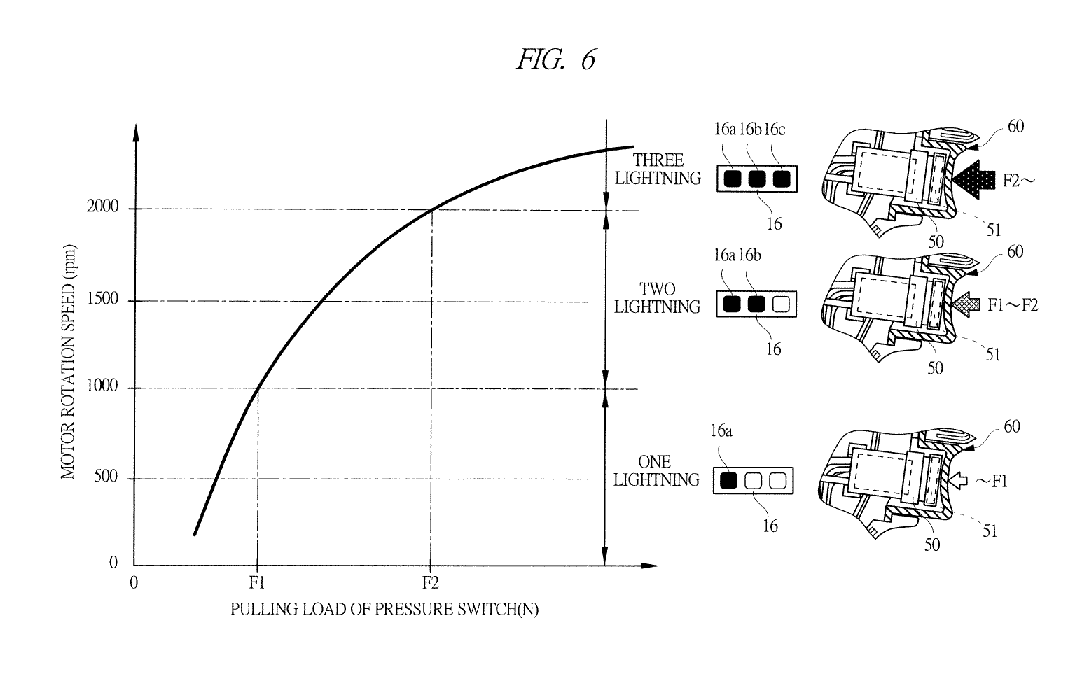

Next, an operation of the impact driver 10 formed as described above will explained in detail with reference to the drawings. FIG. 6 is a characteristic diagram illustrating a relation between a pulling load of the pressure switch and the number of revolutions of the motor, and FIG. 7 is an explanatory view which explains a passage of air flowing inside the housing.

When the worker holds the grip 42 and presses the power switch 51 under the above-described state, the power (driving current) is supplied to each coil 24 of the motor 20 so that the rotor 23 (rotary shaft 21) is rotated at a predetermined number of revolutions. In this manner, the anvil 35 is rotated through the planetary gear mechanism 31, the spindle 32, the cam mechanism 34, and the hammer 33. In this manner, the rotary impacting force is applied to the screw through the tip tool, and, as a result, the screw is exactly screwed into the wood.

At this time, as illustrated in FIG. 6, when the pressing force (pressing amount) of the pressure switch 51 performed by the worker is in a relatively-small region which is “lower than F1(N)”, the number of revolutions of the motor 20 is “lower than 1000 rpm”, and besides, a state of the respective light emitting elements 16a to 16c of the display panel 16 is that one light emitting element is lighted, that is, only the light emitting element 16a is lighted (a state of a low speed rotation is displayed).

Moreover, when the pressing force of the pressure switch 51 performed by the worker is in a middle region which is “higher than F1 (N) and lower than F2 (N)”, the number of revolutions of the motor 20 is “higher than 1000 rpm and lower than 2000 rpm”, and besides, the state of the respective light emitting elements 16a to 16c of the display panel 16 is that two light emitting elements are lighted, that is, the two light emitting elements 16a and 16b are lighted (a state of a middle speed rotation is displayed).

Further, when the pressing force of the pressure switch 51 performed by the worker is in a large area which is “higher than F2 (N)”, the number of revolutions of the motor 20 is “higher than 2000 rpm”, and besides, the state of the respective light emitting elements 16a to 16c of the display panel 16 is that all the three light emitting elements 16a to 16c are lighted (a state of a high speed rotation is displayed).

Here, the operation amount of the pressure switch 51 is smaller than that of the conventional trigger switch, and therefore, it is sometimes difficult for the worker to recognize the operation amount of the pressure switch 51 from his/her touch. In order to support this difficulty, in the present embodiment, the display panel 16 is provided at a position easily viewed by the worker, so that the sufficient operability for the impact driver 10 can be ensured even with the pressure switch 51. Moreover, the characteristics as illustrated in FIG. 6 can be appropriately controlled by the computation unit 72a. For example, in a case for a worker who has a small operation force for operating the pressure switch 51, more rapid changing (larger rate changing) characteristics than the characteristics of FIG. 6 may be used. In a case for a worker who has a large operation force for operating the pressure switch 51, more moderate changing (smaller rate changing) characteristics than the characteristics of FIG. 6 may be used.

During the working of the impact driver 10, the cooling fan 14 is rotated in accordance with the rotation of the rotary shaft 21 as illustrated in FIG. 7. In this manner, the outside air is introduced from each first outside-air introducing hole 41a (see FIGS. 1 and 3) into the housing main body 41, and then, the outside air which has been introduced into the housing main body 41 passes through the motor 20 as indicated by a two-dot chain line arrow “CM” in the drawing, and cools the motor 20. And, the outside air which has passed through the motor 20 is exhausted outside the housing main body 41 through each outside-air exhausting hole 41b (see FIG. 1).

Moreover, the outside air is also introduced into the grip 42 through each second outside-air introducing hole 42a (see FIGS. 2 and 3), and then, the outside air which has been introduced into the grip 42 passes through the control circuit board 70 located in the middle of the air passage 42e as indicated by a two-dot chain line arrow “CC” in the drawing, and cools the electronic parts (switching elements Q1 to Q6 and others) mounted on the front surface and the rear surface of the control circuit board 70. And, the outside air which has passed through the control circuit board 70 is exhausted outside the housing main body 41 through each outside-air exhausting hole 41b.

As described above in detail, according to the impact driver 10 of the present embodiment, the switch housing unit 42b and the control-part housing unit 42c are provided in the housing 40, the switch unit 50 provided with the pressure switch 51 for generating the electric signal by the pressing operation by the worker is housed in the switch housing unit 42b, the switch cover 60 which covers the pressure switch 51 and which is elastically deformed by the pressing operation by the worker so as to seal the switch housing unit 42b is provided, and the control circuit board 70 for controlling the rotation state of the motor 20 in accordance with the magnitude of the electric signal outputted from the pressure switch 51 is housed in the control-part housing unit 42c.

In this manner, by using the pressure switch 51, the dimension in the thickness in the operation direction can be smaller than the dimension in the thickness in the operation direction of the conventional trigger switch, and, as a result, the small size with the lighter weight of the impact driver 10 can be achieved. Moreover, since the pressure switch 51 and the control circuit board 70 are arranged in vicinity of each other inside the housing 40, the control circuit board 70 can be distant away from the heat generating member such as the battery 11, and, as a result, the long life of the impact driver 10 can be achieved.

Further, since the operation amount (pressing amount) of the pressure switch 51 is smaller than the operation amount (sliding amount) of the conventional trigger switch, the operability of the impact driver 10 can be improved. Still further, since the switch cover 60 is provided, the operational touch is softer in the operation of the pressure switch 51 so that the operability thereof can be further improved. Still further, since the switch cover 60 is provided, the pressure switch 51 can be protected from an impact or others, and besides, the entering of the rain water, dust, and others into the housing 40 can be prevented to protect the control circuit board 70, and, as a result, the long life of the impact driver 10 can be achieved.

Still further, since the display panel 16 which displays the rotation state of the motor 20 is provided in the housing 40, the worker can recognize the rotation state of the motor 20 at one view, and, as a result, the operability of the impact driver 10 can be further improved. Still further, since the air passage 42e through which the air flows so as to cross the control-part housing unit 42c is provided inside the housing 40, the cooling efficiency for the control circuit board 70 can be enhanced.

It is needless to say that the present invention is not limited to the above-described embodiment, and various modifications and alterations can be made within the scope of the present invention. In the above-described embodiment, the impact driver 10 has been exemplified as the power tool. However, the present invention is not limited to this, but can be applied to other power tool provided with an electric motor which has a rotary shaft and a housing which houses the electric motor, such as a driver drill and a disc grinder.

Moreover, the above-described embodiment has exemplified the structure in which the partition wall 42d is provided inside the grip 42 forming the housing 40 so as to extend in the longitudinal direction. However, the present invention is not limited to this, but may be applied to a structure in which the outside air flows over the entire area inside the grip 42 with eliminating the partition wall 42d.

Further, the above-described embodiment has exemplified the display unit 16 including three light emitting elements 16a to 16c as the display units. However, the present invention is not limited to this, but may be applied to a liquid crystal display panel which digitally displays the number of revolutions of the motor 20.

What is claimed is:

1. A power tool comprising:
an electric motor which has a rotary shaft;
a housing which houses the electric motor;
a switch housing unit and a control-part housing unit which are provided in the housing;
a pressure switch which is housed in the switch housing unit and which generates an electric signal by performing a pressing operation by a worker;
an operation cover which is provided in the housing and which is elastically deformed by the pressing operation by the worker; and
a control part which is housed in the control-part housing unit and which controls a rotation state of the electric motor in accordance with a magnitude of the electric signal from the pressure switch.

2. The power tool according to claim 1,
wherein a switch unit including the pressure switch is protruded from the switch housing unit.

3. The power tool according to claim 1,
wherein the operation cover is formed of a bottomed main body part and a flange part provided on an opening side of the main body part.

4. The power tool according to claim 1,
wherein the operation cover covers the pressure switch.

5. The power tool according to claim 1,
wherein the operation cover is provided in the housing so as to seal the switch housing unit.

6. The power tool according to claim 1,
wherein a display unit which displays the rotation state of the electric motor is provided in the housing.

7. The power tool according to claim 1,
wherein an air passage through which air flows so as to cross the control-part housing unit is provided in the housing.

8. The power tool according to claim 1,
wherein the housing includes: a housing main body in which the electric motor is housed; and a grip extending from the housing main body, and
the switch housing unit is provided in the grip.

9. The power tool according to claim 8,
wherein the control-part housing unit is provided in the grip.

10. The power tool according to claim 8,
wherein the switch housing unit is provided on one side of a rotary shaft of the electric motor in the grip in an axial direction.

11. The power tool according to claim 10,
wherein the control-part housing unit is provided on the other side of the rotary shaft in the grip in the axial direction.

12. The power tool according to claim 9,
wherein a partition wall is provided in the grip so as to extend in a longitudinal direction of the grip and divide inside of the grip into the switch housing unit side and the control-part housing unit side.

13. The power tool according to claim 8,
wherein the switch unit including the pressure switch is protruded from the grip.
